(19) United States
(12) Patent Application Publication
(10) Pub. No.: US 2008/0166549 A1
(43) Pub. Date: Jul. 10, 2008

(54) Surface protection film for polarizer film

(75) Inventors: Sung-Yueh Shieh, Taipei City (TW); Dein-Run Fung, Taipei County (TW); Chi-Ming Chang, Taoyuan County (TW); Chun-Che Tsao, Taoyuan County (TW); Shih-Hsun Yen, Taipei County (TW)

Correspondence Address: BIRCH STEWART KOLASCH & BIRCH, PO BOX 747, FALLS CHURCH, VA, 22040-0747, US

(73) Assignee: NAN YA PLASTICS CORPORATION

(21) Appl. No.: 11/649,281

(22) Filed: Jan. 4, 2007

(51) Int. Cl. B32B 7/02; B32B 27/06; B05D 1/36; B32B 27/38

(52) U.S. Cl. 428/336; 428/419; 428/413; 427/201

(57) ABSTRACT

The present invention provides a film for the protection of the surface of polarizer film. Said film surface has anti-static coated layer. The coating solution contains polythiophene, surfactant, binding resin and water. According to the present invention, said protection film on the surface on the polarizer film has the excellent anti-static, transmittance, anti-foul and water repellence. It is able to prevent the invasion of imbuing with dust, accumulative anti-static and water vapor from the processing of assembling and transportation so as to influence the quality of polarizer film.

### BACKGROUND OF THE INVENTION

1. Field of the Invention

The present invention relates to a surface protection film for polarizer film. By means of the method of coating on the polymer film, a film having anti-foul and anti-static is produced. Thus the coating solution is mainly consisting of polythiophene and surfactant.

2. Description of the Related Art

The manufacture of liquid crystal indicator is accumulative formations of the optical elements, wherein the outermost layer of the polarizer film is covered by a surface protection film in order to prevent the assembling procedure and the transportation of the polarizer film from being infected with dust to cause the detection incorrectly of optical determination, or to accumulate the static causing the damage of liquid crystal elements and to sock in the moisture causing the trustworthy of the humidity influence of polarizer film.

A general anti-static coating films are widely used, such as photographic plates, electronic packing materials and the other packing materials. Such anti-static coating solutions are the types of the conventionally various surfactants, high molecular compounds and electro-conductivity fillers. However, the anti-static is generally having the defects of unable to keep endurance, easily to be influenced by moisture, the transmittance of film being worse and the transferring pollution of the anti-static agents. Recently, even the conducting high molecular polyaniline and polypyrrole also have the defects of the worse transmittance.

Polythiophene are mainly to be used as coating films. Though they are widely used, there are to exist the adhesiveness of the polymer film being not excellent, the ratio of additive being too high, unable to dissolve with the general binding agents and solvents.

### SUMMARY OF THE INVENTION

In view of the above, the present invention takes advantage of the special water-soluble binding agent and surfactant to lower down the additive ratio of polythiophene, so that the excellent anti-static is keeping, and having the effect of anti-foul and water repellence. Such products are able to bind with the polymer film tightly.

The main purpose of the present invention provides the products including polythiophene, water-soluble binding agent and surfactant for suitable use of coating solution for polymer film, especially used in a surface protection film for polarizer film.

The further purpose of the present invention provides a kind of anti-static polymer film having anti-foul.

Another purpose of the present invention provides a kind of coating solution having high-transmittance.

Another purpose of the present invention provides a kind of coating solution with low cost having excellent anti-foul and anti-static.

Another purpose of the present invention provides a kind of coating solution able to binding with the polymer film tightly.

Another purpose of the present invention provides a kind of ECO-coating solution with organic solvent free.

Another purpose of the present invention provides a kind of coating solution with low frictional coefficient, suitable for the processing of in-line coating so as to decrease the surface damage of the axial extension.

### DETAILED DESCRIPTION OF THE INVENTION

In the present invention, the coating solution is used to form the polarizer film for the use of the surface protection film, wherein the main characteristic is including polythiophene, water-soluble binding agent and surfactant.

In the coating solution in connection with the present invention, the polythiophene provides the mainly anti-static property of surface protection film, the most preferable polythiophene is poly(3,4-ethylene)dioxythiophene (PEDT) which is conductively high polymer material developed by Bayer (i.e. HC Stark, a department of Bayer) and called Baytron P. It is the first commercial anti-static film material applied in the photographic technique. It is to take advantage of polystyrene sulfonic acid (PSS) and PEDT to form ionic high molecular complex, after mixing with water to form dispersion solution of high molecular colloid fine, by means of dispersion solution of high molecular dispersoid particle to make the Baytron P under the coating process to reveal the excellent effect of forming the film. It is to use the PSS in the Baytron P, alcohol compounds, chloryl compounds, epoxy compounds or melamine compounds to process the cross-linking reaction to increase the coating solution having the durability of water and solvents of the properties of the chemical agents.

In the coating solution of the present invention, the amount of polythiophene (Baytron P) added is preferable 0.05-0.5 wt %, more preferable 0.08-0.25 wt %.

In the coating solution in connection with the present invention, the anti-static coating solution is also including the surfactants or the mixtures of surfactants. A general surfactant is including anionic type, cationic-type, non-ionic type, zwitter ionic-type, etc. The coating solution in the present invention adopts anionic type and non-ionic type having a better wetting ability. Further, it has the more excellent dispersible ability to polythiophene. The appearance of the coating film is more transparent and flat. In which, fluorosurfactant is more suitably for the coating solution as mentioned in the present invention. As said fluorosurfactant has excellent properties of wetting capacity, binding, leveling, re-coating ability and the safety of storage, said agent belongs to the material of non-ionic type not easily to foam, and it has extremely excellent effect able to lower down the surface tension. The additive amount of it is less so that it is in the range of RCO-material. The general use of fluorosurfactant is FC4430 and FC4432 of 3M Corporation in USA, Zonyl®FSN-100 of DuPont in USA, DSX of Daikin Co. in Japan, etc.

In the fluorosurfactant of coating solution of the present invention, the amount added is preferable 0.01-0.5 wt %, more preferable 0.05-0.2 wt %.

The coating solution of the present invention belongs to ECO-product, which is not including an obvious amount of organic solvent, for said organic solvent is below 1%. The further characteristic of present invention is to use large amount of water-soluble binding agent. After special improvement of said water-soluble binding agent, it is able to increase binding between coating solution and polymer film, improving the appearance and increasing the transmittance of polymer film after coating, also not influencing the main anti-static character of surface protection film provided by polythiophene. Further, owing to adding specially modified nano level of filler particle in the water-soluble binding agent, the provided polymer film with smoothness has outstanding wind character while manufacturing. It is also not easy to rub against with wheel instrument so as to cause polymer film abrasion.

In the coating solution of the present invention, the water-soluble binding agent includes resin with 2-40 wt %, the filler particle modified by surface treating agent with 0.05-30 wt %, and additive with 0.05-10 wt %, in which the compositions of resin are as follows: a. Including 20-50 wt % ingredient A, wherein the ingredient A being polyester resin; b. including 10-40 wt % ingredient B, wherein the ingredient B being melamine resin or modified melamine resin; c. including 20-80 wt % ingredient C, wherein ingredient C being acrylate resin.

The ingredient A is polyester resin, wherein said polyester resin is the resin with ester chain in the main chain and side chain. Its construction has the water solubility groups, such as —SO₃Na, —SO₃NH4, etc. Said polyester resin can be freely selecting from the conventional polyester resin with water solubility or water dispersion.

The ingredient B is melamine resin or modified melamine resin, such as a hydroxymethyl modified melamine derivative which condensed by melamine and formaldehyde, lower alcohol of hydroxymethyl modified melamine derivative which condensed by melamine and formaldehyde, partial or complete etherification of lower alcohol into hydroxymethyl modified melamine compounds and the mixtures thereof. The melamine can be monomer or condensation compounds with dimmer or more polymers. Further, it also can be the mixtures thereof. The amount of the main ingredient of melamine can be 5-40 wt %, more preferable 01-30 wt %.

The ingredient C is acrylate resin. It can be manufactured by taking advantage of traditionally emulsifying polymerization, in which their ingredients have not been restricted, such as: methyl-acrylate, methyl-methacrylate, ethyl-acrylate, acrylic acid butylester, isooctyl-acrylate, hydroxyethyl-acrylate, hydroxyethyl-methacrylate, acrylamide, methacrylamide, N-hydroxymethylacylamide or N-hydroxymethyl-methacrylamide. The amount of the acrylate resin can be 20-90 wt %, more preferable 30-80 wt %.

Water-soluble binding agent is further containing the modified filler particle with surface treating agent. Said treating agent includes silicon compounds or dispersant or high molecular polymers, or the compounds selecting from one or two or three of them to be treated with filler particles, which have the excellent compatibility between the resin of water-soluble binding agent, whereby to make the filler particles be dispersible in the resin. The filler particles are the inorganic particles of aluminum oxide, aluminum hydroxide, silicon oxide, titanium dioxide, zirconium oxide, calcium carbonate, magnesium carbonate or barium sulfate, etc.

An additive of water-soluble binding agent can be spreading adjuvant, a catalyst, co-solvent, etc, wherein the spreading adjuvant is able to promote the flatness of coating film. Catalyst is able to control the reaction rate of coating film. The catalyst or co-solvent is able to control the volatile rate of liquid ingredients, such as: ethyl alcohol, propanol, isopropyl alcohol, isobutyl alcohol, butyl cellulose, etc.

Water-soluble binding agent includes polyester resin of water solubility radicals, easy dissolving with water; containing modified melamine resin so as to stick with polymer film easily; containing high transparent acrylate resin able to promote the optic property of polymer film, such as transmittance and haze. Further, owing to adding nano level of filler particles modified by surface treating agent, it is very easy to make them dissolve with resin not to cause the optic property become worse. The more amount of additive is added, the sliding of polymer film can be increased, but not to cause optic property to be damaged. Therefore water-soluble binding agent in the coating solution, playing with a very important role, is able to increase the binding with polymer film, to increase optic property, to lower friction coefficient so as to lower abnormal abrasion during processing manufacture.

In the water-soluble binding agent of coating solution of the present invention, the amount added is preferable 1-10 wt %, more preferable 1-5 wt %.

The coating solution of the present invention can contain wide use of additives, such as: chromatic dye or pigment, and other anti-static agents, anti-foam agents, other spreading agents, thickening agent, plasticizer, antioxidant and fillers.

In the coating solution of the present invention, the polyester film being coated such solution has the properties of high transparency, low haze, excellent binding capacity, slipping, etc. Thus it is suitable for the use as the substrate in optics.

In the coating solution of the present invention, the thickness of coating solution on polyester film after coating and drying is preferable 0.001-0.5 μm (micron meter), more preferable 0.01-0.1 μm.

In the coating solution of the present invention, the anti-static properties mainly depend on the surface resistance on the polymer film coated with the coating solution. It can be detected by using the traditional surface resistance analyzer (ADVANTEST R8340A). The surface resistance suitable for use in the present invention is preferable 10¹⁰ ohms per square (Ω/□), more preferable 10⁹ ohms per square (Ω/□), most preferable 10⁸ ohms per square (Ω/□).

In the coating solution of the present invention, the properties of anti-foul and water repellence mainly depend on the surface water contact angle on the polymer film coated with the coating solution. It can be detected by using water contact angle analyzer (Kyo-Wa Surface Science, CA-D). The surface water angle suitable for use in the present invention is preferable above 88°, more preferable 90°-100°, most preferable above 100°.

In the coating solution of the present invention, the properties of optics mainly depend on the transmittance and haze on the polymer film coated with the coating solution. It can be detected by using transmittance and haze analyzer (NIPPON DENSHOKU, TC-HIIIDPK). The transmittance and haze suitable for use in the present invention is preferable above 88% and below 5%, more preferable above 90% and below 3%, most preferable above 92% and below 1%.

The formation of the protection film for polymer film in present invention is mainly applying the anti-static properties, such as: nylon film, polystyrene film, polymethyl methacrylate film, poly carbonate film, polyvinyl film, polyacryl film, polyvinyl chloride film, polyethene glycol terephthalate film etc., in which the one having the properties of transmittance, economics, recovery is preferable, and the most preferable one is polyethene terepthalate film.

The coating method used in the present invention is able to adopt the traditional methods of roll coating, reverse roll coating, gravure roll coating, reverse gravure roll coating, brush coating, wire-wound rod (Meyer rod) coating, spray coating, air knife coating and dipping. Besides so-called traditional method of off-line process mentioned above in the present invention, it also can use the coating method of so-called in-line process. The manufacturing process of PET is used as an example. In the process of the manufacture of polymer film, and before thermosetting of said polymer film, it is coated with the coating solution of the present invention. The coated polymer film is processing the procedures of directional extension and heating formalization. The above two coating methods can obtain the treating polymer film with the transmittance above 90%, haze below 3%, surface resistance below 10⁹ ohms per square (Ω/□) and water contact angle above 90°.

### EXAMPLES

The following examples are used to explain the present invention more definitely. However, the scope of present invention is not limited to those examples.

### Examples and Comparative Examples

According to the compositions listed in Table 1, the amount used is based on weight percent wt %, and by means of stirring of a stirrer, the coating solution can be obtained. The coating solution obtained by such way can be coated on the PET film (model BS-21, thickness 38 μm) manufactured by NAN-YA PLASTICS CORPORATION by means of reverse gravure roll coating. At 100° C. dried with a certain time by using drier with warm air, the polymer film with thickness 0.03-0.3 μm is obtained.

TABLE 1
examples and comparative examples

| | | | | | | | | Comparative | | |
|---|---|---|---|---|---|---|---|---|---|---|
| | | examples | | | | | | examples | | |
| | | 1 | 2 | 3 | 4 | 5 | 6 | 1 | 2 | 3 |
| Polythiophene | Baytron P | 0.06 | 0.12 | 0.25 | 0.25 | 0.25 | 0.06 | 0.06 | 0.12 | 0.25 |
| Fluorosurfactant | FC-4430 | 0.2 | 0.2 | 0.2 | 0.1 | 0.05 | 0.2 | 0.05 | 0.1 | 0.2 |
| Water-soluble | NY-1 | 1.8 | 1.8 | 1.8 | 1.8 | 1.8 | 5.0 | — | — | — |
| binding agent | | | | | | | | | | |

| | | | | | | | | | |
|---|---|---|---|---|---|---|---|---|---|
| Surface resistance (Ω/□) | 9.51 × 10⁹ | 4.78 × 10⁹ | 1.86 × 10⁹ | 1.22 × 10⁹ | 9.1 × 10⁸ | 1.58 × 10⁹ | 8.54 × 10⁹ | 3.71 × 10⁹ | 1.07 × 10⁹ |
| Water contact angle (degree) | 106 | 106 | 106 | 104 | 102 | 105 | 103 | 104 | 106 |
| Transmittance (%) | 90.5 | 90.2 | 89.5 | 89.7 | 89.7 | 92.0 | 88.1 | 89.2 | 89.7 |
| Haze (%) | 1.8 | 1.8 | 1.8 | 1.6 | 1.4 | 1.8 | 1.4 | 1.5 | 1.6 |
| Binding ability with polymer | ◯ | ◯ | ◯ | ◯ | ◯ | ◯ | X | X | X |
| film | | | | | | | | | |
| Friction coefficient (static | 0.45/ | 0.44/ | 0.45/ | 0.42/ | 0.40/ | 0.41/ | 0.45/ | 0.47/ | 0.52/ |
| friction/dynamic friction) | 0.36 | 0.35 | 0.35 | 0.32 | 0.31 | 0.31 | 0.36 | 0.38 | 0.41 |

According to the result mentioned above, the increasing amounts of polythiophene (Baytron P) of coating solution provided by the surface protection film for polarizer film in the present invention are done, and the surface resistance is to lower down then. The water contact angle has the obvious efficacy while the fluorosurfactant is added about 0.05%. While the water-soluble binding agents in the coating solution, it is not only to increase the binding of polymer film, but also to improve the optic properties, such as transmittance and haze. Following the increasing of amounts, the friction coefficient is to lower down then. Thus the scratch abnormal can be reduced while processing extension.

What we claimed is:

1. A polymer film surface coated with anti-foul, water repellence and anti-static, such film containing:
(A) polymer film;
(B) coating solution coated on the film, such coating solution containing (1) polythiophene, (2) special water-soluble binding agent with amount at least above 1%, (3) surfactant, (4) cross-linking agent reacted with polythiophene.

2. The polythiophene as claimed in claim 1, wherein said polythiophene being poly(3,4-ethylene)dioxythiophene.

3. The surfactant as claimed in claim 1, wherein said surfactant containing fluorosurfactant.

4. The special water-soluble binding agent as claimed in claim 1, wherein said special binding agent containing resin, filler particles modified with surface treating agents and additives.

5. The cross-linking agent reacted with polythiophene as claimed in claim 1, wherein said cross-linking agent containing epoxy compounds and melamine compounds.

6. The polymer film (A) as claimed in claim 1, wherein said polymer film (A) containing high molecular polyester.

7. The polythiophene as claimed in claim 1, wherein the amount of said polythiophene in coating solution being 0.05-0.5 wt %.

8. The special water-soluble binding agent as claimed in claim 1, wherein the amount of said special water-soluble binding agent in coating solution being 1-10 wt %.

9. The surfactant as claimed in claim 1, wherein said amount of said surfactant in coating solution being 0.01-0.5 wt %.

10. The coating solution as claimed in claim 1, wherein the thickness of coated layer on polymer film being 0.001-0.5 μm.

11. The treated polymer film as claimed in claim 1, wherein the surface resistance of said film being 10⁸-10¹⁰ ohms per square (Ω/□).

12. The treated polymer film as claimed in claim 1, wherein the surface water contact angle of said film being 102°-106°.

13. The treated polymer film as claimed in claim 1, wherein the transmittance of said film being 89-92%.

14. The resin as claimed in claim 4, wherein said resin containing the following compositions of two or three ingredients:
a. Including 20-50 wt % polyester resin;
b. including 10-40 wt % melamine resin or modified melamine resin;
c. including 20-60 wt % acrylate resin.

15. The treating agents as claimed in claim 4, wherein said agents being at least one selected from silane or high molecular polymer.

16. The filler particles as claimed in claim 4, wherein said filler particles being at least one selected from the materials of aluminum oxide, silicon oxide, titanium oxide, zirconium oxide, calcium carbonate or barium sulfate.

17. A method for coating the surface polymer film with anti-foul, water repellence and anti-static in claim 1, wherein said method containing the processing of off-line coating and the processing of two axial extension of in-line coating.
